(19) United States
(12) Patent Application Publication
(10) Pub. No.: US 2002/0075623 A1
(43) Pub. Date: Jun. 20, 2002

(54) Modem protection circuit

(76) Inventors: Michael John Maytum, Willington (GB); Steven Wilton Byatt, Bromham (GB)

Correspondence Address: Howard J. Klein, Klein & Szekeres, LLP, Ste. 700, 4199 Campus Dr., Irvine, CA, 92612, US

(21) Appl. No.: 10/023,925

(22) Filed: Dec. 18, 2001

(30) Foreign Application Priority Data
Dec. 20, 2000 (GB) UK 0030991.4

(51) Int. Cl. H02H 1/00

(52) U.S. Cl. 361/119

(57) ABSTRACT

A protection circuit is provided for a telecommunications device which has first and second conductors for transmitting and receiving signals to and from the communications device, signal circuitry for processing the signals and switch means for selectively connecting the conductors to the signal circuitry. The circuit comprises a protection circuit means connectable between the first and second conductors and comprising first and second switch means having first and second voltage threshold values. Current monitoring means are provided for monitoring the current through one of the conductors. The first and second switch means are arranged to switch from a first, non-conducting state to a second, conducting state in response to the voltage across the conductors exceeding the first and second combined threshold voltage values, thereby to provide overvoltage protection at a first voltage magnitude. The monitoring means is also operable to switch the first switch means from a non-conducting to a conducting state in response to current through the one of the conductors exceeding a preselected threshold value, thereby to enable the second switch means to provide overvoltage protection at a second voltage magnitude less than the first voltage magnitude during operation of the telecomnunications device.

### BACKGROUND OF THE INVENTION

The present invention relates generally to the field of overcurrent and overvoltage protection devices and circuits. More specifically, it relates to a circuit for the protection of modems, and particularly, but not exclusively, to circuitry for protecting the “hook switch” of a modem from excessive currents when the hook switch is closed.

Conventionally, modems are provided with protection circuitry for protecting the components of the modems from overvoltages and currents. Protection from excessive currents is often achieved by means of a fuse, while active switching devices are employed to protect the components from overvoltages.

### SUMMARY OF THE INVENTION

The present invention aims to provide an improved means of overvoltage and current protection for telecommunication devices, and, in particular, modems.

Accordingly, the present invention provides an overvoltage protection circuit for a telecommunications device, wherein: said telecommunications device has first and second conductors for transmitting and receiving signals to and from said communications device, signal circuitry for processing said signals and switch means for selectively connecting said conductors to said signal circuitry, the protection circuit comprising: switching means connectable between said first and second conductors and having upper and lower voltage threshold switching values, said switching means being switchable between said upper and lower voltage threshold switching values thereby to provide overvoltage protection at upper and lower voltage magnitudes; and current sensing means for monitoring the current through one of said conductors; wherein said current sensing means is operable to switch said switching means from said upper voltage threshold switching value to said lower voltage threshold switching value in response to said current through said one of said conductors exceeding a preselected value thereby to provide overvoltage protection at said lower voltage magnitude during operation of said telecommunications device.

In a preferred form of the invention said switching means comprises first and second switch means having first and second voltage threshold values; said first and second voltage threshold values combined form said upper threshold switching value and said second voltage threshold value forms said lower threshold switching value; said first and second switch means are arranged to switch from a first, non-conducting state to a second, conducing state in response to the voltage across said conductors exceeding said first and second combined threshold voltage values, thereby to provide overvoltage protection at said upper voltage magnitude; and said current sensing means is operable to switch said first switch means from a non-conducting to a conducting state in response to current through said one of said conductors exceeding said preselected threshold value, thereby to enable said second switch means to provide overvoltage protection at said lower voltage magnitude during operation of said telecommunications device.

In a second aspect of the invention a protection circuit is provided for a telecommunications device having first and second conductors for transmitting and receiving signals to and from said communications device, signal circuitry for processing said signals and switch means for selectively connecting said conductors to said signal circuitry, the circuit comprising: protection circuit means connectable between said first and second conductors and comprising first and second switch means having first and second voltage threshold values; and current monitoring means for monitoring the current through one of said conductors; wherein: said first and second switch means are arranged to switch from a first, non-conducting state to a second, conducting state in response to the voltage across said conductors exceeding said first and second combined threshold voltage values, thereby to provide overvoltage protection at a first voltage magnitude; and said monitoring means is operable to switch said first switch means from a non-conducting to a conducting state in response to current through said one of said conductors exceeding a preselected threshold value, thereby to enable said second switch means to provide overvoltage protection at a second voltage magnitude less than said first voltage magnitude during operation of said telecommunications device.

In a preferred form of the invention said second switch means is a thyristor means. Said first switch means has a voltage threshold value which is greater than the threshold value of said second switch means.

Advantageously, said current monitoring means comprises resistance means in said one of said conductors; and wherein said first switch means is switched from its non-conducting to its conducting state in response to the current through said resistance means generating a preselected voltage.

Preferably, said first switch means comprises a triac means.

Advantageously, said first switch means comprises a silicon controlled rectifier.

Preferably, said first switch means comprises a parallel combination of P and N gate silicon controlled rectifiers; and said monitoring means is operable to switch one of said silicon controlled rectifiers from a non-conducting to a conducting state in response to current of a first polarity through said one of said conductors exceeding a preselected threshold value, and to switch the other of said silicon controlled rectifiers from a non-conducting to a conducting state in response to current of the opposite polarity through said one of said conductors exceeding a preselected threshold value.

Conveniently, said second switch means comprises a break-over diode means.

In a further preferred form of the invention the circuit has first and second current sensing means for monitoring the current through respective ones of said conductors; wherein: said first and second switch means comprise two series connected silicon controlled rectifiers having the same gate polarity and a respective break-over diode means connected in anti-parallel with each said silicon controlled rectifier; said first monitoring means is operable to switch one of said silicon controlled rectifiers from a non-conducting to a conducting state in response to current of a first polarity through said one of said conductors exceeding a preselected threshold value; and said second monitoring means is operable to switch the other of said silicon controlled rectifiers from a non-conducting to a conducting state in response to current of the opposite polarity through the other of said conductors exceeding a preselected threshold value.

### BRIEF DESCRIPTION OF THE DRAWINGS

The present invention will now be described by way of example only, with reference to the accompanying drawings in which:

FIG. 1 is a block circuit diagram of a modem incorporating conventional overvoltage and overcurrent protection;

FIG. 2 is a block circuit diagram of a modem incorporating a preferred embodiment of an overvoltage and overcurrent protection circuit according to the invention;

FIG. 3 illustrates a first specific construction for the protection circuit of FIG. 2;

FIG. 4 illustrates a second specific construction for the protection circuit of FIG. 2;

FIG. 5 illustrates a third specific construction for the protection circuit of FIG. 2;

FIG. 6 illustrates a possible silicon structure for the circuit of FIG. 3;

FIG. 7 illustrates a possible silicon structure for the circuit of FIG. 4;

FIG. 8 shows a possible silicon structure for the circuit of FIG. 5; and

FIGS. 9a and 9b show two forms of a unidirectional protection circuit according to the invention.

### DETAILED DESCRIPTION OF THE INVENTION

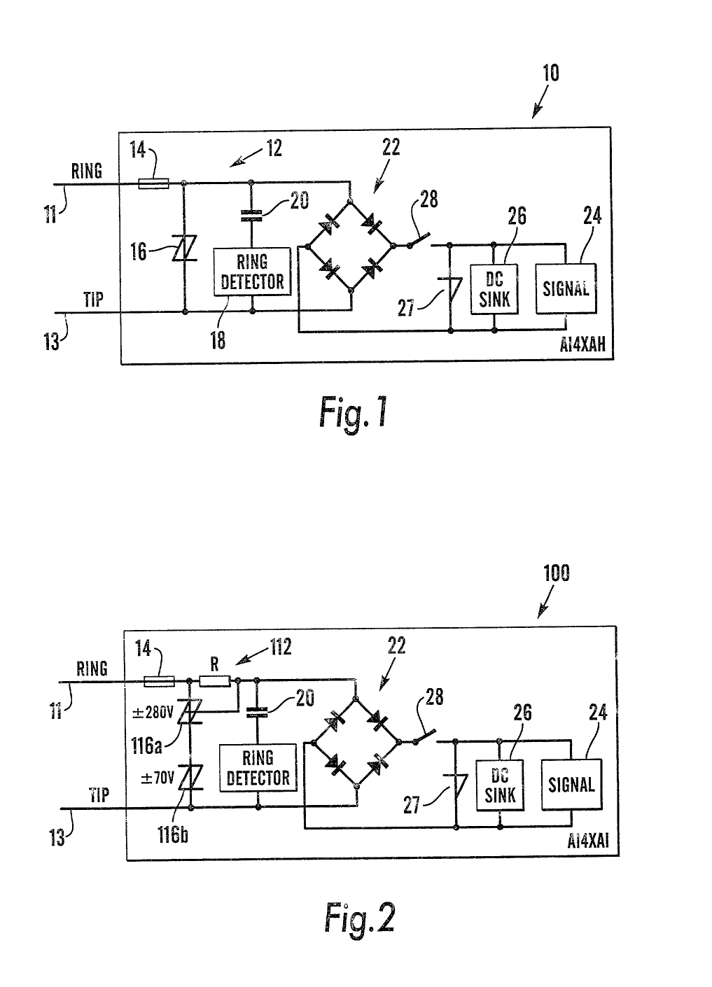

Referring to FIG. 1, a typical modem circuit is shown in block form generally at 10. The modem circuit 10 is coupled to the ring and tip lines 11, 13 of a telecommunication network in the conventional manner. The modem includes an input protection circuit 12 in the form of a fuse 14 serially connected to the ring line and a switching type protector 16 coupled across the ring and tip lines. To comply with government regulations, the protector 16 is required to provide a protection voltage of a certain minimum value. In many countries, this protection voltage is 350 volts. The modem also has ring detector circuitry 18 connected in series with a coupling capacitor 20 across the ring and tip lines. To prevent damage to the modem circuitry caused by the reversal of the ring and tip lines 11, 13, the modem is provided with a rectifier bridge 22 to ensure that the modem circuitry receives the correct voltage polarity.

The modem also includes a signal circuit 24 which transmits and receives signals between the line and the isolated signal processing circuitry. Typically, isolation is achieved with a transformer, opto-couplers or capacitors. A DC sink 26 draws an appropriate line current to register to the exchange that the modem is in an active receive or transmit state. Typically the line open circuit voltage is about 50 volts and can source currents in the range of 30 milliamps to 80 milliamps. The voltage developed across the DC sink is usually in the range of 10 volts to 25 volts. Both the signal circuit 24 and the DC sink 26 are coupled over the outputs of the rectifier bridge 22 via a hook switch 28. Overvoltage protection for the signal circuit 24 and the DC sink 26 is provided by a protector device 27 which may be in the form of a clamping (zener) or switching type device. It provides a typical protection voltage level of about 70 volts.

The hook switch may be mechanical or electronic and is usually designed to block overvoltages up to the ring-tip protection voltage of, e.g., 350 volts. In its open state, the switch is capable of surviving excessive voltages up to 350 volts. However, in the closed state, high currents can flow through the switch causing excessive power dissipation and heat within the switch. For example, unless the fuse 12 blows quickly, the contacts of a mechanical switch may weld together. Electronic switches on the other hand, are incapable of dissipating more than a few watts on average. This is particularly significant since the testing of such switches normally involves the application of a 50 or 60 Hertz AC voltage over the switch. During the voltage rise (at approximately 200V/ms) between zero and the protection voltage of 350V, an electronic switch limiting at 0.2 A dissipates approximately 30 W for 1.5 ms. Over half a cycle this averages to approximately 4.5 W. Unless the fuse operates extremely rapidly, catastrophic switch failure can occur.

Ideally, when the hook switch 28 is in a closed condition, the voltage should be limited to a lower value, typically around 70V. However, incorporating a 70V protector in place of the 350V protector 16 across the ring and tip lines would prevent the modem from working properly, because ringing voltages, which can be up to 275V, would be clipped.

FIG. 2 shows a modem 100 incorporating a preferred embodiment of an input protection circuit 112 according to the invention which, advantageously, operates to provide 70V protection when the hook switch 28 is closed and 350V protection when the hook switch is open. The modem includes all of the components provided in the modem of FIG. 1. However, in the present invention, the single protector 16 of the input protection circuit 12 is replaced by a pair of protectors 116a, 116b connected in series between the ring and tip lines. The first protector 116a has a protection voltage of ±280V and the second protector 116b has a protection voltage of ±70V. The series combination of a 70V and a 280V protector gives an overall protection voltage of 350V as required during AC testing procedures. In addition, a resistor R is connected in the ring line 11 between the anode of the 280V protector 116a and the capacitor 20, with the gate electrode of protector 116a also connected to the ring line on the opposite side of the resistor R to the protector anode.

In this manner the 280V first protector 116a can be gate-triggered by the current flowing through the resistor R when the hook switch 126 is closed. The first protector 116a therefore effectively becomes short circuited such that protection is then provided solely by the 70V second protector 116b. Since 70V protection is provided by the protector 116b, this may remove the need for the protector 27 which can then be omitted.

Thus, the protection circuit 112 provides 350V protection when the hook switch is open and 70V protection when the switch is closed and drawing line current. This is achieved by sensing the line current flow through the resistance R and using this current (by way of the voltage drop across the resistance R) to switch between 350V and 70V protection. In addition, the 70V second protector 116b has a minimum holding current which is higher than the maximum DC line current, typically at a value of 150 mA. This ensures that the second protector 116b switches off after it has switched on irrespective of whether the hook switch is open or closed. In this case, the first protector 116a does not need to have a holding current which is higher than the line DC current.

It will also be appreciated that the voltages 350V, 280V and 70V are used for illustrative purposes only, and the actual values of the voltages will depend on the modem components and the communications system with which the modem is intended to be used.

In addition, the resistance R may be a discrete resistor, external to the first protector 116a or integrated into the protection device.

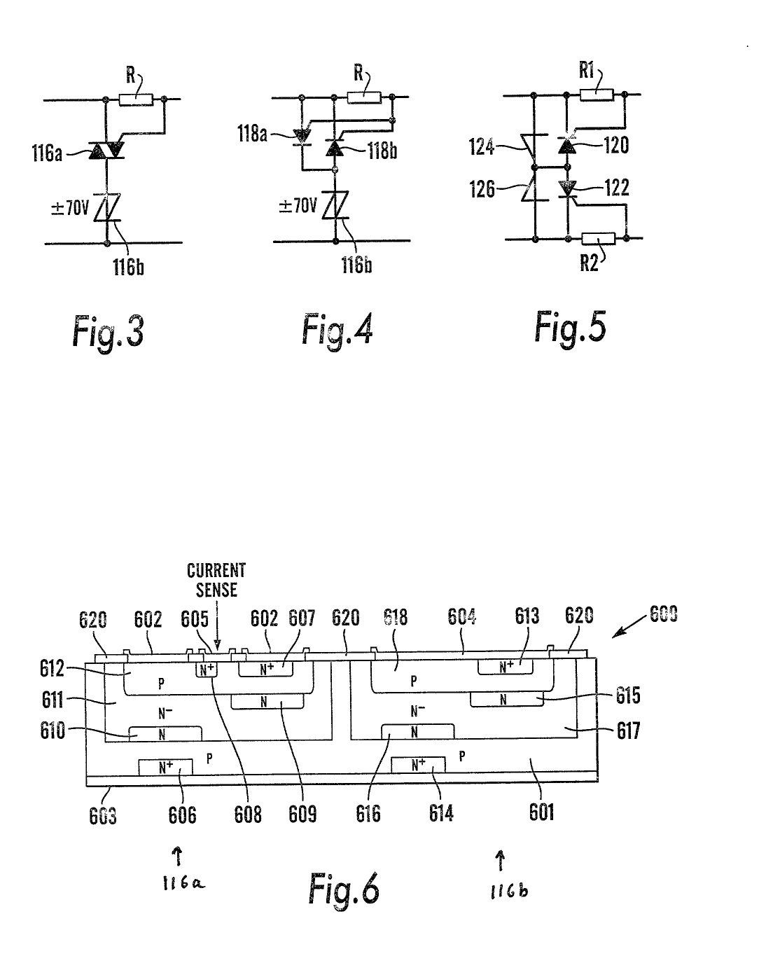

FIGS. 3, 4, and 5 illustrate specific constructions for the protection circuit 112 of FIG. 2. In FIG. 3, the 280V, the gate-triggered first protector 116a is implemented by a triac, and in FIG. 4, by a parallel combination of P-gate and N-gate silicon controlled rectifiers (SCR) 118a, 118b, respectively. In FIG. 5, the first protector 116a comprises two SCRs 120, 122 with the same type of gate having 70V break-over diodes (BOD) 124, 126 connected in anti-parallel. In this case, in any one polarity there is the series combination of an SCR and a BOD (120 and 126 or 122 and 124). A respective resistance R1, R2 is used in each conductor to monitor the current and trigger the associated SCR when the voltage across the resistance reaches the SCR trigger voltage.

FIGS. 6, 7, and 8 illustrate possible silicon structures for the protection circuits of FIGS. 3, 4, and 5, respectively. FIG. 6 shows a possible silicon structure 600 for the protector of FIG. 3 with the triac 116a formed on the left side of the structure and the ±70 v protector device on the right side as seen in FIG. 6. The structure has a silicon block 601 with metalisations 602, 604 and 603 formed on the upper and lower surfaces. The lower metalisation 603 forms the connection between the triac 116a and the thyristor 116b while the upper metalisations 602, 604 form the first line conductor (ring line) 11 and the second line conductor (tip line) 13 respectively. A further metalisation 605 forms the gate electrode of the triac 116a. The triac 116a has a N⁻ substrate 611, 617 and is formed by N⁺ regions 606, 607, 608, N regions 609, 610,—region 611 and P region 612. The ±70V second protector 116b is formed by N⁺ regions 613, 614, N regions 615, 616, N⁻ region 617 and P region 601, 618. Oxide layers are shown at 620.

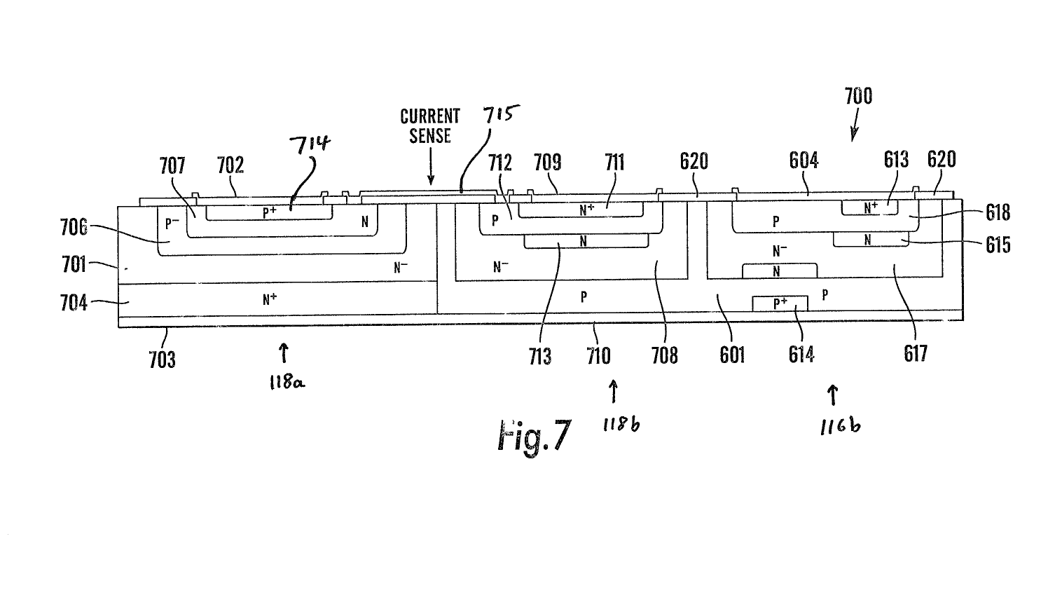

FIG. 7 shows a possible silicon structure 700 for the protection circuit of FIG. 4. The ±70V protector is formed in the same manner as that of FIG. 6. The N gate SCR is formed on a N⁻ substrate 701 having metalisations 702, 703 on the upper and lower surfaces, respectively. The SCR itself is formed from an N⁺ region 704 between the substrate 701 and the lower metalisation 703, and P⁻, N and P⁺ regions 706, 707, 714 respectively, between the substrate 701 and the upper metalisation 702. The P gate SCR is formed from an N⁻ substrate 708 having upper and lower metalisations 709, 710, respectively, a P region 601 between the substrate 708 and the lower metalisation 710, and N⁺, P and N regions 711, 712, 713, respectively. In this embodiment, the lower metalisation is common to both SCRs and the 70V protector. The upper metalisations 702 and 709 form the first line conductor (ring line) 11, and the upper metalisation of the 70V protector forms the second line conductor (tip line) 13.

The N gate 707 of the SCR 118a and the P gate 712 of the SCR 118b are electrically connected in this example by a metal strap or metalisation 715.

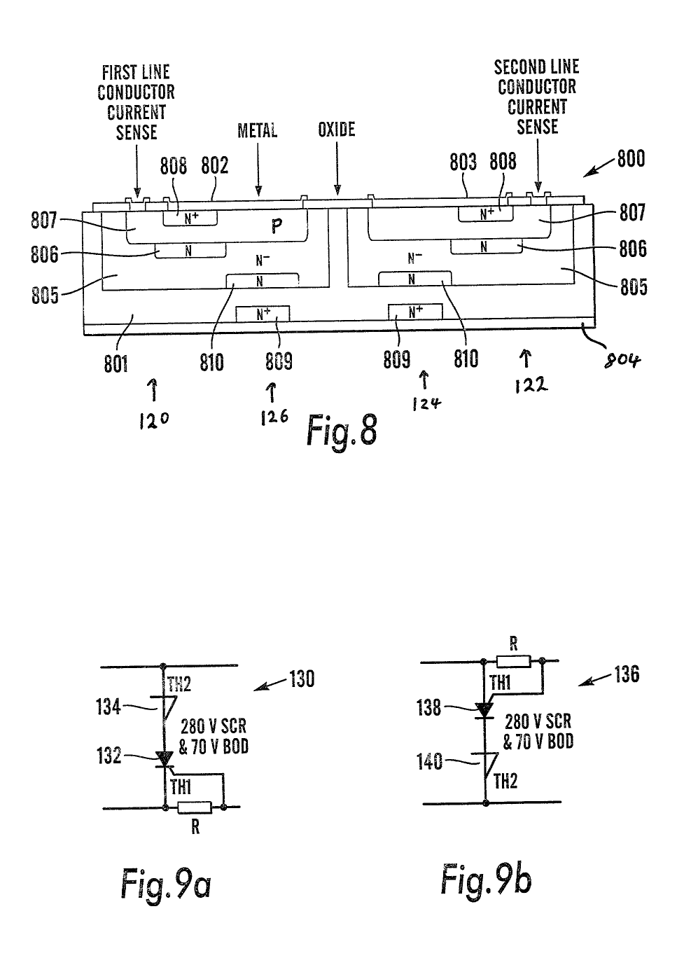

FIG. 8 shows a possible silicon structure 900 for the protection circuit of FIG. 5. The protection circuit is formed in a P-type semiconductor block 801 having upper metalisations 802, 803, respectively, forming the first line conductor (ring line) 11 and second line conductor (tip line) 13, respectively, and a lower metalisation 804. The first 280V SCR 120 and the 70V break-over diode 126 are shown in the left hand side of the structure of FIG. 8. The SCR 120 is formed from P, N⁻, N, P and N⁺ regions 01, 805, 806, 807, 808, respectively. The 70V break-over diode 126 is formed from N⁺, P, N, N⁻ and P regions 809, 801, 810, 805 and 807 respectively. The second SCR/break-over diode pair 122, 124 is formed in an identical manner in the right hand side of the structure.

In FIG. 2, the hook switch is shown as being connected after the rectifier bridge on the DC circuitry side. It will be appreciated that the protection circuit 112 could be connected after the polarity bridge 22 and before the hook switch 28. In this case, the protection circuit can be uni-directional instead of bi-directional, and FIGS. 9a and 9b show two preferred forms of uni-directional protection circuits. These two figures illustrate the complimentary versions of a 280V SCR 132, 138 in series with a 70V BOD 134, 140 and represent the individual current carrying paths of Figure 4. In FIG. 9a the protection circuit 130 has an SCR 132 in series with a breakover diode (BOD) 134. The SCR 132 is triggered by the voltage drop across the resistance R. In FIG. 9b the protection circuit 136 has an SCR 138 in series with a breakover diode (BOD) 140. The SCR 138 is triggered by the voltage drop across the resistance R.

What is claimed is:

1 An overvoltage protection circuit for a telecommunications device, wherein:
said telecommunications device has first and second conductors for transmitting and receiving signals to and from said communications device, signal circuitry for processing said signals and switch means for selectively connecting said conductors to said signal circuitry, the protection circuit comprising:
switching means connectable between said first and second conductors and having upper and lower voltage threshold switching values, said switching means being switchable between said upper and lower voltage threshold switching values thereby to provide overvoltage protection at upper and lower voltage magnitudes;
and current sensing means for monitoring the current through one of said conductors;
wherein said current sensing means is operable to switch said switching means from said upper voltage threshold switching value to said lower voltage threshold switching value in response to said current through said one of said conductors exceeding a preselected value thereby to provide overvoltage protection at said lower voltage magnitude during operation of said telecommunications device.

2 A circuit as claimed in claim 1 wherein:
said switching means comprises first and second switch means having first and second voltage threshold values;
said first and second voltage threshold values combined form said upper threshold switching value and said second voltage threshold value forms said lower threshold switching value;
said first and second switch means are arranged to switch from a first, non-conducting state to a second, conducing state in response to the voltage across said conductors exceeding said first and second combined threshold voltage values, thereby to provide overvoltage protection at said upper voltage magnitude;
and said current sensing means is operable to switch said first switch means from a non-conducting to a conducting state in response to current through said one of said conductors exceeding said preselected threshold value, thereby to enable said second switch means to provide overvoltage protection at said lower voltage magnitude during operation of said telecommunications device.

3 A protection circuit as claimed in claim 1 wherein:
said second switch means is a thyristor means.

4 A protection circuit as claimed in claim 1 wherein:
said first switch means has a voltage threshold value which is greater than the threshold value of said second switch means.

5 A protection circuit as claimed in claim 1 wherein said current monitoring means comprises resistance means in said one of said conductors;
and wherein said first switch means is switched from its non-conducting to its conducting state in response to the current through said resistance means generating a preselected voltage.

6 A protection circuit as claimed in claim 1 wherein said first switch means comprises a triac means.

7 A protection circuit as claimed in claim 1 wherein said first switch means comprises a silicon controlled rectifier.

8 A protection circuit as claimed in claim I wherein said first switch means comprises a parallel combination of P and N gate silicon controlled rectifiers;
and said monitoring means is operable to switch one of said silicon controlled rectifiers from a non-conducting to a conducting state i. response to current of a first polarity through said one of said conductors exceeding a preselected threshold value, and to switch the other of said silicon controlled rectifiers from a non-conducting to a conducting state in response to current of the opposite polarity through said one of said conductors exceeding a preselected threshold value.

9 A protection circuit as claimed in claim 1 wherein said second switch means comprises a break-over diode means.

10 A protection circuit as claimed in claim 1 comprising:
first and second current sensing means for monitoring the current through respective ones of said conductors;
wherein:
said first and second switch means comprise two series connected silicon controlled rectifiers having the same gate polarity and a respective break-over diode means connected in anti-parallel with each said silicon controlled rectifier;
said first monitoring means is operable to switch one of said silicon controlled rectifiers from a non-conducting to a conducting state in response to current of a first polarity through said one of said conductors exceeding a preselected threshold value;
and said second monitoring means is operable to switch the other of said silicon controlled rectifiers from a non-conducting to a conducting state in response to current of the opposite polarity through the other of said conductors exceeding a preselected threshold value.

11 A protection circuit for a telecommunications device having first and second conductors for transmitting and receiving signals to and from said communications device, signal circuitry for processing said signals and switch means for selectively connecting said conductors to said signal circuitry, the circuit comprising:
protection circuit means connectable between said first and second conductors and comprising first and second switch means having first and second voltage threshold values;
and current monitoring means for monitoring the current through one of said conductors;
wherein:
said first and second switch means are arranged to switch from a first, non-conducting state to a second, conducting state in response to the voltage across said conductors exceeding said first and second combined threshold voltage values, thereby to provide overvoltage protection at a first voltage magnitude;
and said monitoring means is operable to switch said first switch means from a non-conducting to a conducting state in response to current through said one of said conductors exceeding a preselected threshold value, thereby to enable said second switch means to provide overvoltage protection at a second voltage magnitude less than said first voltage magnitude during operation of said telecommunications device.

12 A protection circuit as claimed in claim 11 wherein:
said second switch means is a thyristor means.

13 A protection circuit as claimed in claim 11 wherein:
said first switch means has a voltage threshold value which is greater than the threshold value of said second switch means.

14 A protection circuit as claimed in claim 11 wherein said current monitoring means comprises resistance means in said one of said conductors;
and wherein said first switch means is switched from its non-conducting to its conducting state in response to the current through said resistance means generating a preselected voltage.

15 A protection circuit as claimed in claim 11 wherein said first switch means comprises a triac means.

16 A protection circuit as claimed in claim 11 wherein said first switch means comprises a silicon controlled rectifier.

17 A protection circuit as claimed in claim 11 wherein said first switch means comprises a parallel combination of P and N gate silicon controlled rectifiers;
and said monitoring means is operable to switch one of said silicon controlled rectifiers from a non-conducting to a conducting state in response to current of a first polarity through said one of said conductors exceeding a preselected threshold value, and to switch the other of said silicon controlled rectifiers from a non-conducting to a conducting state in response to current of the opposite polarity through said one of said conductors exceeding a preselected threshold value.

18 A protection circuit as claimed in claim 11 wherein said second switch means comprises a break-over diode means.

19 A protection circuit as claimed in claim 11 comprising:
first and second current sensing means for monitoring the current through respective ones of said conductors;
wherein:
said first and second switch means comprise two series connected silicon controlled rectifiers having the same gate polarity and a respective break-over diode means connected in anti-parallel with each said silicon controlled rectifier;
said first monitoring means is operable to switch one of said silicon controlled rectifiers from a non-conducting to a conducting state in response to current of a first polarity through said one of said conductors exceeding a preselected threshold value;
and said second monitoring means is operable to switch the other of said silicon controlled rectifiers from a non-conducting to a conducting state in response to current of the opposite polarity through the other of said conductors exceeding a preselected threshold value.
